(19) United States
(12) Patent Application Publication
(10) Pub. No.: US 2025/0223185 A1
(43) Pub. Date: Jul. 10, 2025

(54) PROCESS FOR OBTAINING RE OXIDES

(71) Applicant: HyProMag GmbH, Pforzheim (DE)

(72) Inventor: Nelson Da Mota Brito, Pforzheim (DE)

(73) Assignee: HyProMag GmbH, Pforzheim (DE)

(21) Appl. No.: 18/852,718

(22) PCT Filed: Mar. 16, 2023
(86) PCT No.: PCT/EP2023/056823

§ 371 Date: Sep. 30, 2024

(30) Foreign Application Priority Data
Mar. 28, 2022 (DE) 10 2022 107 216.9

(51) Int. Cl. C01F 17/206; C22B 1/00; C22B 3/16; C22B 3/22

(52) U.S. Cl. CPC C01F 17/206; C22B 1/005; C22B 3/1608; C22B 3/22

(57) ABSTRACT

A process for obtaining rare earth (RE) oxides from a starting material including one or more RE compounds of formula REFeB is provided. The process includes the following steps: comminuting the starting material by hydrogen hydrogenation (HPMS); treating the comminuted starting material with an aqueous solution of a carboxylic acid or a mixture of multiple carboxylic acids; precipitating the RE oxides from the carboxylic acid solution by addition of a precipitant that includes an alcohol or a mixture of multiple alcohols. The RE oxides themselves and the use thereof are also provided.

### CROSS-REFERENCE TO RELATED APPLICATIONS

This application is a 371 National Phase of PCT/EP2023/056823, filed Mar. 16, 2023, which claims priority from German Patent Application No. 10 2022 107 216.9, filed Mar. 28, 2022, both of which are incorporated herein by reference as if fully set forth.

### TECHNICAL FIELD

The present invention relates to a process for obtaining RE oxides and to the RE oxides themselves that are produced according to the process. The invention further relates to the use of RE oxides of this kind.

### BACKGROUND

“Rare earths” or “rare earth metals”, abbreviation RE, refers to elements of transition group 3: scandium (Sc) and yttrium (Y), and lanthanum (La) and the fourteen elements following it: cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu).

The two names, rare earths or rare earth metals, are partially misleading. On the one hand, the compounds are exclusively metals and, on the other hand, these metals are not rare, but rather are distributed quite evenly in the Earth's crust. There are historical reasons for the terms. When these elements were discovered, they were initially able to be found only in rare minerals and be isolated only in oxidic forms, at that time called “earths”. Nowadays, they can be obtained in highly pure form and can be found in many places in the Earth's crust.

The estimated average concentration of rare earths in the Earth's crust, an Earth's mantle thickness of about 17 km, is about 150 to 220 ppm. The proportion of the individual elements is quite different. Mostly commonly found is the element cerium at about 40-60 ppm; the “rarest” of the rare earths is thulium, which is however still about as common as the element bismuth in the Earth's crust, but 30 times less so than cerium.

In some regions, the concentrations of rare earths are considerably higher. If the rock has a concentration of about ≥0.1% of rare earths, which corresponds to 1000 ppm, i.e. 1 kg of rare earths per ton of rock, such cases are referred to as a rare earth deposit (RE deposit). In order however for an occurrence of minerals to be prospected as an exploitable deposit, further economic, ecological but also political criteria have to be met.

Due to ever-increasing requirements and criteria, it is becoming ever more complicated and expensive to extract rare earths from the natural sources. At the same time, however, the consumption of these specific metals increases from year to year. What is interesting is the sharp increase in the consumption of selected RE elements. Up until 1995 it was around 100 [t/a], but from 2000 it increased a hundredfold for some rare earths.

In 2012, 95% of rare earths were processed in seven major fields of application:
magnets for wind turbines, hybrid motors and electric drives;
catalysts for the chemical industry;
alloys for steel casting, batteries, flints, fuel cells and lightweight constructions;
polishing agents;
glasses: color and UV filters;
phosphors such as LED, LCS;
ceramics for stabilizers and capacitors.

The remaining 5% were quantitatively distributed among various, but sometimes no less important, applications. The very strong increase in consumption from 2000, as described above, cannot be attributed to the expansion of the previous areas of application of ceramics, glass production, polishing agents or catalysts, but rather is caused by the emergence of new fields of application, especially by the production of magnetic materials, but also by the use as phosphors. A rapidly growing use of rare earths is in batteries. Mischmetal (a mixture of rare earths) is a constituent of nickel hybrid batteries, which are gradually replacing nickel-cadmium batteries in the power supply of portable electronic devices such as laptops and cell phones. A further increasing use of rare earths is in the production of permanent magnets. Samarium-cobalt permanent magnets are used in industry, in the military and in space flight. More powerful and at the same time less expensive neodymium-iron-boron magnets are used in a plurality of actuators in cars (window regulators, power steering, headlight range control, seat adjustment, etc.), in medical magnetic resonance devices, industrial motors, wind turbines, CD players and stereo systems. Strongly growing fields of application are traction motors for hybrid and electric vehicles, and stepper motors and sensors in automation and robotics. In addition, about 6% of rare earths are needed for the doping of phosphors in the lighting industry and screen industry, and in oxygen sensors.

The result of the new rapidly growing fields of application is that neodymium, praseodymium, dysprosium and terbium are currently among the rare earth metals with the highest demand. There is a high demand in particular due to their diverse field of use in powerful permanent magnets for efficient motors, generators, sensors, acoustics and optics. Due to a further increasing importance of electric drives and generators (electromobility, wind power), with a simultaneous shortage of these rare earths as raw materials on the world market, an efficient, environmentally friendly and cost-effective recycling process for rare earths is required, in particular since the current recycling rate worldwide is only approx. 1-3%.

There are already known methods that deal with this topic and take different approaches. Most of them relate to the recycling of neodymium, since neodymium is of the greatest interest from a technological perspective. The methods from the prior art that are described in detail below can however be adapted to all rare earths.

In order to recover neodymium from single-type NdFeB material, the production of NdFeB magnets has to date mainly used powder-metallurgical processes, such as hydrogen embrittlement (HPMS process), as described in US 2012/0137829 A1. This process has the advantage of high environmental friendliness, since little energy consumption is required and no chemical waste is produced. However, the powder-metallurgical processes require that the starting material to be recycled is characterized by a very high level of purity. In the case of an impure starting material, the purity of the recovered Nd compound becomes insufficient and the Nd compounds recovered from the by means of this process cannot be used for the production of high-quality magnets. Furthermore, the recycling of maximum-performance magnets (N48, N50 etc.) by means of the HPMS process requires a complex prior removal of oxide and hydroxide layers by for example cyclone separation, which enables only a very low yield. Moreover, a protective layer of tin, nickel, aluminum or a spray-coating or dip-coating lacquer is usually also applied to sintered NdFeB magnets. This can mean high process-engineering requirements for the recycling by hydrogen embrittlement and makes a recycling process difficult in the case of magnetic material of different origin and composition.

Different recovery processes in comparison with powder-metallurgical processes are various hydrometallurgical recycling processes, which in principle offer better possibilities for material separation by way of wet-chemical procedures.

WO 94/26665 A1 discloses a process in which the digestion of the starting material to be recycled comprising NdFeB, for example by a superficial oxidation of NdFeB by means of NaOH to form an oxide Nd₂O₃, which is then dissolved in acetic acid, selectively crystallized out as neodymium acetate by concentration, fluorinated and then reduced to elemental neodymium. However, it has been found to be disadvantageous in this process that only a superficial oxidation of the NdFeB to Nd₂O₃ is possible. This results in a very slow digestion rate and the need for continuous mechanical comminution during the digestion process with simultaneous magnetic separation of elemental iron.

U.S. Pat. No. 5,129,945 B1 discloses that the digestion of process wastes from rare earth magnet production can be effected with 2M H₂SO₄. By addition of NaOH or NH₄OH, the double salt NaNd(SO₄)₂·H₂O or NH₄Nd(SO₄)₂·H₂O, respectively, is selectively precipitated from the solution. The addition of hydrofluoric acid subsequently fluorinates the double salt to NdF₃, which after careful drying is then calciothermically reduced again to elemental Nd. However, this procedure is problematic due to the use and the release of hydrogen fluoride (HF). As an alternative to HF, U.S. Pat. No. 5,129,945 B1 describes a reaction of the double salt with an oxalic acid solution to form neodymium oxalate, which can be decomposed to form Nd₂O₃, CO₂ and H₂O by thermal treatment at 900° C. However, what is disadvantageous here is a further required salt metathesis step in connection with the loss of the oxalic acid used.

DE 10 2012 0174 18 B4 discloses a process for obtaining the double salt NaNd(SO₄)₂·H₂O from a precomminuted starting mixture that contains NdFeB. In the process, a magnetic separation and a fine comminution are carried out and then a hydrometallurgical digestion is carried out with addition of sulfuric acid, with simultaneous determination of the hydrogen volume flow released during the hydrometallurgical digestion or of the total hydrogen volume released, with the released hydrogen volume flow or the total hydrogen volume being used as a control variable for the amount of sulfuric acid to be added and/or being used to determine the completion of the hydrometallurgical digestion. This is followed by precipitation of the sparingly soluble double salt NaNd(SO₄)₂·H₂O after the hydrometallurgical digestion by addition of a sodium-containing salt solution, a sodium-containing salt and/or NaOH. However, the solution disclosed in said document has proven to be disadvantageous inasmuch as the addition of sulfuric acid and following that the addition of a sodium-containing salt solution, a sodium-containing salt and/or NaOH the sparingly soluble double salt NaNd(SO₄)₂·H₂O has to be precipitated after the hydrometallurgical digestion, is laborious and expensive both in the use and the processing of the chemicals obtained.

In summary, it can be said that one of the main obstacles for the effective recycling of rare earths from used magnetic materials by hydrometallurgical processes is a lack of or only insufficient control of the digestion in the case of magnet-containing materials of different origin with varying nature and composition. As a result, the required time for the digestion is very long depending on the composition and nature of the material to be recycled (for example due to passivation and agglomeration, but also inert extraneous materials that cannot be removed in any other way) and both the digestion itself and the subsequent precipitation require unnecessarily high use of chemicals.

Furthermore, it is problematic that NdFeB-containing scrap/waste from different sources can contain different impurities that do not occur in single-type process wastes from magnet production—these include for example other rare earth magnets such as SmCo. In such a case, for example only the precipitation of a mixed double salt such as NaNd1-x Sm(SO₄)₂·H₂O is performed with subsequent solvent extraction or ion exchange in order to separate the rare earths. However, this procedure is very complex and impedes a simple recycling process. Other ways of separation during the digestion, such as by hydrogen flotation processes (U.S. Pat. No. 5,238,489 B1), can be realized in used materials only with difficulty, or cannot be realized at all, due to other impurities (for example from plastics).

Moreover, none of the known recycling processes can efficiently recycle mixed, non-single-type magnetic materials that are subject to fluctuations in composition and nature.

### SUMMARY

In view of this, the present invention is based on the object of providing possibilities for effective recovery of RE oxides that, on the one hand, enable efficient recovery from unsorted waste/scrap with reduced outlay and, on the other hand, are environmentally friendly with respect to the chemicals used.

This object is achieved by a process for obtaining RE oxides having one or more of the features disclosed herein. Advantageous configurations of this process are found in the description and claims that follow.

Furthermore, the object on which the invention is based is likewise achieved by the RE oxides produced by the process, and by the use of the RE oxides.

The process according to the invention for obtaining RE oxides from a starting material comprising one or more RE compounds of formula REFeB comprises the following steps:
a) comminuting the starting material by means of hydrogen hydrogenation (HPMS);
b) treating the comminuted starting material with an aqueous solution of a carboxylic acid or a mixture of multiple carboxylic acids; and
c) precipitating the RE oxides from the carboxylic acid solution by addition of a precipitant that comprises an alcohol or a mixture of multiple alcohols.

In the context of the present invention, the term “RE oxides” should be understood to mean oxides of the rare earths or of the rare earth metals: scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu).

In the context of the present invention, the term “starting material” should be understood to mean materials comprising one or more RE compounds of formula REFeB and consisting of single-type magnet wastes, mixed magnet wastes, unsorted scrap or waste.

In contrast to the methods and processes known from the prior art, the process for obtaining RE oxides according to the present invention has the considerable advantage that it features a high level of variability and flexibility in the possible uses. Above all, the process according to the invention enables recycling of non-single-type starting materials comprising RE compound(s) of formula REFeB such as scrap or waste, since the flexibility of the process means that it can be very rapidly adapted to the starting materials and mixtures thereof with varying composition and nature. Furthermore, the process according to the invention avoids the use of very questionable or toxic chemicals, which considerably increases the environmental compatibility of the process according to the invention.

In the first step a) of the process according to the invention, starting material comprising one or more RE compounds of formula REFeB is subjected to a hydrogen treatment in accordance with US 2012/0137829 A1, it being possible to comminute the material beforehand depending on the initial state.

The resulting powder, what is called HPMS powder, may be separated from any impurities such as adhesives, coatings, fixings, casing residues, etc. for example by sieving or other suitable methods. This step and the method can be easily adapted depending on which starting material or which starting material mixture is subjected to the inventive recycling process.

According to one embodiment, the HPMS powder obtained in step a) has a particle size in the range from 1 μm to 1000 μm. Preferably, the comminuted starting material has a particle size in the range from 1 μm to 125 μm. More preferably, the comminuted starting material has a particle size in the range from 1 μm to 63 μm. Most preferably, the comminuted starting material has a particle size in the range from 1 μm to 25 μm.

The powder that is prepared in this way and optionally purified is treated in step b) with an aqueous solution of a carboxylic acid or a mixture of multiple carboxylic acids. The hydrometallurgical digestion according to step b) may be carried out in the degassed or non-degassed state.

Depending on the composition of the starting material, in step b) the powder may be completely or partially dissolved by the addition of a carboxylic acid or a mixture of multiple carboxylic acids.

In step c), the RE oxides in the solution are precipitated by addition of a precipitant that comprises an alcohol or a mixture of multiple alcohols. The precipitated RE oxides are removed by skimming off, filtering or other suitable separation methods.

The remaining carboxylic acid solution is neutralized for example with sodium carbonate, and residues are filtered off.

In the case that the powder has only partially been dissolved in step b), it is optionally possible according to a further embodiment after step b) to carry out a step b′), in which the hard-magnetic Φ phase that is undissolved in the carboxylic acid solution and that comprises RE₂Fe₁₄B is separated from the solution before the precipitation step c).

After the digestion reaction in step b) has ended, the undissolved REFeB powder, which now consists of single crystal particles of the hard-magnetic Φ phase (RE₂Fe₁₄B), is separated from the carboxylic acid solution, washed and dried.

After step b′), the carboxylic acid solution is subjected to step c), where the RE oxides formed precipitate by addition of a precipitant that comprises an alcohol or a mixture of multiple alcohols. The precipitated RE oxides are removed by skimming off, filtering or other suitable separation methods.

The remaining carboxylic acid solution is neutralized for example with sodium carbonate, and residues are filtered off.

What is thus achieved by the process according to the invention is that the process can be rapidly adapted depending on the composition of the starting material to be recycled.

The highly pure RE oxide precipitated from the carboxylic acid solution in step c) may be reduced by known processes to RE metals, which for example are fed back directly to the magnet production process.

The single crystal powder obtained in step b′) that consists of hard-magnetic Φ phase (Nd₂Fe₁₄B) is completely freed of RE oxide and hydroxide layers; any agglomerates of crystals connected by RE-rich phase that remain after the HPMS process are separated so that the dried powder can be directly used for the production of maximum-performance magnets.

To produce maximum-performance sintered magnets, the single crystal powder according to the invention can be mechanically alloyed by adding appropriate proportions of RE powder (metallic or hydrogenated), pressed and subjected to a suitable heat treatment.

To produce new magnets, the single crystal powder can be provided with suitable single-layer or multi-layer grain boundary phases made of metallic, ceramic or organic layers and be converted into a magnetic solid by means of suitable joining processes.

The process according to the invention is particularly suitable for the recovery of rare earths from mixed magnet scraps, such as those produced in shredder plants for WEEE recycling. In this case, the non-separated magnet scrap is subjected as an agglomerate to the HPMS treatment according to step a). Since from the magnet scrap only the RE proportion of the REFeB magnets forms corresponding hydrides and a reaction of the carboxylic acid with the other substances, if any, has very much slower reaction kinetics, it is possible by way of mechanical removal of the formed HPMS powder to subject this or all of the scrap agglomerate to a hydrometallurgical digestion according to step b). After completion of the reaction, the carboxylic acid solution can be separated and this can be subjected to step c) to obtain highly pure RE oxide.

In the same manner, the process may also be used for highly contaminated magnet scrap with a single-type but low RE magnet proportion, such as audio modules from smartphones. After use of a suitable shredder method, as described for example in DE 10 2018 221 845 A1, and an HPMS treatment according to step a), the magnets that are highly contaminated with housing, adhesive and coil residues are subjected to a hydrometallurgical digestion according to step b). After completion of the reaction, removal of the carboxylic acid solution can take place and this can then be subjected to step c) in order to obtain highly pure RE oxide.

The process according to the invention also has the considerable advantage over the processes from the prior art that it is significantly quicker. The efficiency of this process is demonstrated for example in direct comparison with the digestion process described in U.S. Pat. No. 5,129,945 B1. In said document, the complete digestion according to the exemplary embodiments requires 24 h, while in the present invention the total duration of the digestion only takes a few minutes, as can be seen from the examples.

In a further configuration of the invention, during step b) the pH of the solution is readjusted by further addition of the carboxylic acid or the mixture of multiple carboxylic acids so that it does not exceed a value of 3.5. Preferably, the pH does not exceed 3. More preferably, the pH does not exceed 2.5. Most preferably, the pH does not exceed 1.5. In particular cases, the pH does not exceed 1.

As has been shown in many experiments, in contrast to the prior art, the present invention does not require a problematic measurement and controlled adjustment of the pH for the precipitation reaction, since the acid concentration of the carboxylic acid during the hydrometallurgical digestion is already in the optimal range with regard to product purity and yield. However, if acceleration of this step is desired, it is possible to readjust the pH so that it does not exceed 3.5.

According to one embodiment, the carboxylic acid is a monocarboxylic acid selected from the group consisting of: saturated carboxylic acids, aromatic carboxylic acids, monounsaturated carboxylic acids and polyunsaturated carboxylic acids.

According to a further embodiment, the carboxylic acid is a saturated monocarboxylic acid.

According to a further embodiment, the carboxylic acid is an aromatic monocarboxylic acid.

According to a further embodiment, the carboxylic acid is a monounsaturated monocarboxylic acid.

According to a further embodiment, the carboxylic acid is a polyunsaturated monocarboxylic acid.

According to a further embodiment, the carboxylic acid is selected from the group consisting of: formic acid, acetic acid, propionic acid, butyric acid, valeric acid, lauric acid, palmitic acid, stearic acid, arachidic acid, lignoceric acid, benzoic acid; oleic acid, elaidic acid; sorbic acid, linoleic acid, linolenic acid and arachidonic acid.

According to a further embodiment, the carboxylic acid is formic acid.

According to a further embodiment, the carboxylic acid is acetic acid.

According to a further embodiment, the carboxylic acid is palmitic acid.

According to a further embodiment, the carboxylic acid is stearic acid.

According to a further embodiment, the carboxylic acid is benzoic acid.

According to a further embodiment, the carboxylic acid is a dicarboxylic acid.

According to a further embodiment, the carboxylic acid is a dicarboxylic acid selected from the group consisting of: oxalic acid, malonic acid, succinic acid, fumaric acid, maleic acid, tartaric acid, adipic acid and phthalic acid.

According to a further embodiment, the carboxylic acid is oxalic acid.

According to a further embodiment, the carboxylic acid is succinic acid.

According to a further embodiment, the carboxylic acid is maleic acid.

According to a further embodiment, the carboxylic acid is tartaric acid.

According to a further embodiment, the carboxylic acid is adipic acid.

According to a further embodiment, the carboxylic acid is phthalic acid.

According to a further embodiment, the carboxylic acid is a tricarboxylic acid.

According to a further embodiment, the carboxylic acid is a tricarboxylic acid selected from the group consisting of: isocitric acid, citric acid, aconitic acid, propane-1,2,3-tricarboxylic acid, agaric acid and trimesic acid.

According to a further embodiment, the carboxylic acid is isocitric acid.

According to a further embodiment, the carboxylic acid is citric acid.

According to a further embodiment, the carboxylic acid is aconitic acid.

According to a further embodiment, the carboxylic acid is agaric acid.

According to a further embodiment, use may likewise be made of a mixture of multiple carboxylic acids. The mixing ratios may vary depending on the acids used.

In one configuration of the invention, the mixture comprises two different carboxylic acids in a ratio from 100:1 to 1:100, preferably from 50:1 to 1:50, more preferably from 10:1 to 1:10.

In a further configuration of the invention, the mixture comprises three different carboxylic acids. In this case, the ratio of the first two carboxylic acids is as described above. The ratio of carboxylic acid 1 to carboxylic acid 3 is from 100:1 to 1:100, preferably from 50:1 to 1:50, more preferably from 10:1 to 1:10.

According to a further embodiment, the concentration of the aqueous solution of the carboxylic acid or the mixture of multiple carboxylic acids is at least 5% and at most 99%. According to preferred embodiments, the carboxylic acid or the mixture of multiple carboxylic acids is at least 30% strength, more preferably 60% strength, most preferably 90% strength.

According to one embodiment, the precipitant is an alcohol selected from the group consisting of: methanol, ethanol, propan-1-ol, propan-2-ol, butan-1-ol, butan-2-ol, isobutanol, tert-butanol, glycol, propylene glycol, propane-1,3-diol, glycerol, pentaerythritol.

Preferably, the precipitant is an alcohol selected from the group consisting of: methanol, ethanol, propan-1-ol, butan-1-ol, butan-2-ol, isobutanol, tert-butanol.

Further preferably, the precipitant is an alcohol selected from the group consisting of: methanol, ethanol, butan-1-ol, tert-butanol.

According to one embodiment, the alcohol is methanol.

According to a further embodiment, the alcohol is ethanol.

According to a further embodiment, the alcohol is butan-1-ol.

According to one embodiment, the precipitation in step c) is achieved by addition of a liquid precipitant.

According to a further embodiment, the precipitation is achieved by addition into a liquid precipitant.

In one embodiment, all steps of the process according to the invention are carried out at room temperature. In a further embodiment, the process is carried out at elevated temperatures of 70-90° C. Depending on the starting material used, it may be desirable to heat the carboxylic acid solution in step b) in order to increase the solubility and thus to shorten the reaction time.

In a further embodiment, after step a) magnetic separation takes place, whereby the demagnetized RE compounds are removed from the starting material and/or only magnetized (remanent) ferro- and ferrimagnetic compounds are removed.

This measure contributes to the process according to the invention being able to be flexibly adapted to the starting material to be recycled.

In a further embodiment, before magnetic separation the RE compounds are demagnetized by heating to above their Curie temperature and/or the use of alternating electromagnetic fields.

Further advantageous properties of the invention are described and explained in more detail below on the basis of examples and experiments.

### EXAMPLE 1

### Obtaining of RE Oxides From Single-Type Waste Magnets From a Wind Turbine

200 g of HPMS powder, obtained from single-type waste magnets from a wind turbine, is stirred in a liter of a mixture of tartaric acid (50%), formic acid (35%) and oxalic acid (15%) with a pH of 2 for 45 minutes at 80° C. The acid solution is then separated from the powder. The magnet powder, which is completely freed of the RE-rich grain boundary phase, has a weight of 99.25 g.

The RE oxide dissolved in the acid mixture is precipitated using ethanol and after drying has a weight of 272.70 g.

### EXAMPLE 2

### Obtaining of RE Oxides From Magnet Waste From Audio Modules From a Smartphone

Shredded magnet waste from 100 audio modules from a smartphone is largely separated from polymer residues by way of magnetic separation and is subjected to an HPMS treatment. The resulting 40 g of HPMS powder is stirred in 0.5 liters of a mixture of tartaric acid (55%), formic acid (30%) and citric acid (15%) with a pH of 2 for 60 minutes at 80° C. The acid solution is then separated from the powder. The RE oxide dissolved in the acid mixture is precipitated using ethanol and after drying has a weight of 76.25 g.

1. A process for obtaining RE oxides from a starting material comprising one or more RE compounds of formula REFeB, said process comprising the following steps:
a) comminuting the starting material by hydrogen hydrogenation (HPMS) to form comminuted starting material;
b) treating the comminuted starting material with an aqueous solution of a carboxylic acid or a mixture of multiple carboxylic acids; and
c) precipitating the RE oxides from the carboxylic acid solution by addition of a precipitant that comprises an alcohol or a mixture of multiple alcohols.

2. The process as claimed in claim 1, further comprising during step b), readjusting the pH of the solution by further addition of the carboxylic acid or the mixture of multiple carboxylic acids so that the pH does not exceed a value of 3.5.

3. The process as claimed in claim 1, further comprising after step b) carrying out a step b′) that includes separating the hard-magnetic Φ phase that is undissolved in the carboxylic acid solution and that comprises RE₂Fe₁₄B from the solution before the precipitation step c).

4. The process as claimed in claim 1, wherein the starting material comminuted in step a) has a particle size in a range from 1 μm to 1000 μm.

5. The process as claimed in claim 1, wherein the carboxylic acid is a monocarboxylic acid selected from the group consisting of: saturated carboxylic acids, aromatic carboxylic acids, monounsaturated carboxylic acids, and polyunsaturated carboxylic acids.

6. The process as claimed in claim 5, wherein the monocarboxylic acid is selected from the group consisting of:
formic acid, acetic acid, propionic acid, butyric acid, valeric acid, lauric acid, palmitic acid, stearic acid, arachidic acid, lignoceric acid; benzoic acid, oleic acid, elaidic acid; sorbic acid, linoleic acid, linolenic acid, and arachidonic acid.

7. The process as claimed in claim 1, wherein the carboxylic acid is a dicarboxylic acid selected from the group consisting of: oxalic acid, malonic acid, succinic acid, fumaric acid, maleic acid, tartaric acid, adipic acid, and phthalic acid.

8. The process as claimed in claim 1, wherein the carboxylic acid is a tricarboxylic acid selected from the group consisting of: isocitric acid, citric acid, aconitic acid, propane-1,2,3-tricarboxylic acid, agaric acid, and trimesic acid.

9. The process as claimed in claim 1, wherein the alcohol is selected from the group consisting of: methanol, ethanol, propan-1-ol, propan-2-ol, butan-1-ol, butan-2-ol, isobutanol, tert-butanol, glycol, propylene glycol, propane-1,3-diol, glycerol, and pentaerythritol.

10. The process as claimed in claim 9, wherein the alcohol is methanol.

11. The process as claimed in claim 9, wherein the alcohol is butanol.

12. The process as claimed in claim 1, further comprising after step a) carrying out magnetic separation, whereby at least one of demagnetized RE compounds are removed from the starting material or only magnetized (remanent) ferro- and ferrimagnetic compounds are removed from the starting material.

13. The process as claimed in claim 12, further comprising before magnetic separation, demagnetizing the RE compounds by at least one of heating to above a Curie temperature thereof or using alternating electromagnetic fields.

14. RE oxides produced by the process as claimed in claim 1.

15. A magnet comprising the RE oxides of claim 14.
